(19) United States
(12) Patent Application Publication
(10) Pub. No.: US 2011/0197581 A1
(43) Pub. Date: Aug. 18, 2011

(54) ACTUATOR

(76) Inventors: Jörg Jennes, Bockenheim (DE); Jochen Schäflein, Stuttgart (DE); Tobias Dettmann, Ruterberg (DE); Stefan Bedö, Stuttgart (DE); Klaus Czerwinski, Heimsheim (DE); Dirk Naunheim, Stuttgart (DE)

(21) Appl. No.: 13/025,871

(22) Filed: Feb. 11, 2011

(30) Foreign Application Priority Data
Feb. 13, 2010 (DE) 102010007895.6

(51) Int. Cl. F02D 23/00; F16H 25/08

(52) U.S. Cl. 60/602; 74/25

(57) ABSTRACT

An actuator includes a transmission element configured to transmit a mechanical regulating signal, a guide element and a transmission element mounted on the guide element. The guide element has an inner surface facing the transmission element. The transmission element has an outer surface facing the guide element, wherein the guide element includes at least one radial groove.

The present invention relates to an actuator, particularly a pneumatic actuator, for the regulation of a variable turbine geometry of an exhaust gas turbocharger with the features of the preamble of claim 1.

From U.S. Pat. No. 4,403,538 a pneumatic actuator for use on an exhaust gas turbocharger is known. The pneumatic actuator comprises a diaphragm arranged in a housing, dividing the housing into two parts separated from each other, which diaphragm is connected to a transmission rod. Through pressure differentials between the regions of the pneumatic actuator, the transmission rod is translatorically moved because of the movement of the diaphragm. For guiding the transmission rod, the latter is mounted in a guide bush arranged in the housing. Such a pneumatic actuator is used for the control for example of a wastegate valve of the exhaust gas turbocharger.

In U.S. Pat. No. 6,352,019 B1 a similar pneumatic actuator is likewise described, wherein this embodiment comprises a guide bush whose inner surface facing the transmission element has a rounded-off shape for reducing the friction between the guide bush and the transmission element. Because of this, the friction surface between the transmission rod and the guide bush is reduced.

The present invention deals with the problem of stating an improved or an at least other embodiment for such a generic actuator, which is more preferably characterized by a reduced friction between transmission element and guide element. According to the invention, this problem is solved through the subjects of the independent claims. Advantageous embodiments are the subject of the dependent claims.

The invention is based on the general idea, with an actuator, particularly with a pneumatic actuator for the regulation of a variable turbine geometry and/or of a waste gate valve of an exhaust gas turbocharger, with a transmission element for the transmission of a mechanical regulating signal and a guide element mounting the transmission element, of equipping an inner surface of the guide element facing the transmission element and/or an outer surface of the transmission element facing the guide element with at least one radial groove. Through the formation of such a radial groove a contact surface between the transmission element and the guide element is reduced and thus also the friction that occurs with an assumed constant contact pressure. In addition, upon formation of at least one such radial groove, the guiding length defined by the guide element can be maintained subject to the reduction of the contact surface and the concomitant friction between guide element and transmission element.

This principle of the friction reduction can be applied with all actuators where an input quantity is converted into a movement, while the movement generated by the actuator is transmitted to a further component through a transmission element such as for example a regulating rod. Practically the transmission element is secured against movements transverse to the longitudinal axis of the transmission element through a guide element. Preferably such a transmission element-guide element combination is employed with pneumatic actuators. With these preferably employed pneumatic actuators a diaphragm is arranged within a pressure-tight housing so that the housing is subdivided into two regions by the diaphragm, which regions are separated from each other in a pressure-tight manner. Because of pressure differentials in these two separate regions the diaphragm and a transmission element connected to the diaphragm, which can transmit the diaphragm movement to a further component, move. The transmission element of the actuator can be designed as rod or as regulating rod. Here, a round as well as an angular shape is conceivable as cross section of the rod. In the case of a pneumatic actuator, the transmission element transmits a translation in orientation of the longitudinal axis of the transmission element triggered by the diaphragm. However, it is also conceivable with another shape of the actuator to transmit a rotary movement by means of the transmission element. In the event of the transmission of a rotation the transmission element has to be of a substantially round design.

Practically, an inner contour of the guide element is substantially designed complementarily to the substantial cross-sectional shape of the transmission element. The guide element, particularly with a pneumatic actuator, on the one hand has the function of defining the position of the transmission element, which is above all advantageous with respect to an accurate position detection through a sensor if necessary, more preferably position sensor. In addition, by using a guide element an assembly of the actuator generating the movement is less intensively subjected to transverse forces acting transversely to the longitudinal direction of the transmission element on the latter. This brings with it an increase of the lifespan of the actuator. On the other hand, the guide element seals off the inner region of the actuator from the environment so that a lifespan-reducing dirt ingress from the outside into the interior of the actuator is reduced or prevented.

As materials for the transmission element and/or the guide element, metals, metal alloys and plastics can be used. It is advantageous as a rule to produce guide elements from PPS.

In order to guarantee an adequate guidance of the transmission element through the guide element, a certain guiding length is necessary. Here, the guiding length means the length of the transmission element region which in each case is arranged in the guide element. In this region of the transmission element an inner surface of the guide element facing the transmission element and an outer surface of the transmission element facing the guide element contact each other. This contact surface creates a friction force acting on the transmission element which counteracts the movement of the transmission element. The substantial disadvantage of this friction between transmission element and guide element is the hysterisis of the actuator that occurs because of the friction force. Because of the position difference between outward and return movement of the transmission element caused through the hysterisis the fineness of the regulation possible through the actuator is limited. Accordingly, a reduction of the friction results in an improvement of the regulating quality of the actuator among other things.

Through radial grooves, which are formed on the inner surface of the guide element facing the transmission element and/or on the outer surface of the transmission element facing the guide element it is possible to reduce the friction surface. Here, the radial grooves extend from an inner surface of the guide element facing the transmission element or from the outer surface of the transmission element facing the guide element into the respective element. Such radial grooves can be designed in different depths or extension into the element. Such radial grooves can be designed as ring grooves running in circumferential direction of the respective element or as longitudinal grooves running in axial direction of the respective element. Both on the transmission element and also on the guide element, only longitudinal grooves, only ring grooves or longitudinal and ring grooves crossing one another on an element can be formed in each case.

It is likewise conceivable to form at least one spiral groove which runs at an angle to the longitudinal axis on the transmission element and/or on the guide element. Spiral grooves can be designed as thread-shaped ring grooves open on both sides, wherein the pitch of such a thread-shaped spiral groove can be variably designed, just as is the number of the spiral turns formed.

Advantageous in the formation of at least one ring groove in the guide element can be the maintaining of the guide length with simultaneous reduction of the friction surface. In the event of forming at least one ring groove on the inner surface of the guide element, the guide lengths can be maintained through the forming of ring webs in the end position just as by forming longitudinal grooves. By maintaining the guide length the transverse forces that can occur on the transmission element transmittable through the transmission element if applicable are reduced, which leads to an increase of the lifespan of the actuator.

The radial grooves can substantially have a rectangular, triangular or trapezium-shaped cross section. Several webs, delimiting the radial grooves, which can develop because of the formation of the radial grooves, can have a rounded-off, a trapezium-shaped, a rectangular or a pointed end region.

The hysterisis regarding an outward and return movement of the transmission element, because of the friction between transmission element and guide element, can be additionally or alternatively improved also with a lubricating coating because of the reduction of the friction through the lubrication of this coating. Thus it is possible to provide a coating of the transmission element designed for instance as regulating rod with for example a Teflon layer, an MoS₂-layer a chromium layer or the like. Such lubricating coatings can be applied both onto the entire regulating rod as well as partially in the region of the guide element and in a lift region of the transmission element during the operation.

In addition it is conceivable, in contrast with a currently usual design of PPS, to produce the guide element completely or at least in the guide region from Teflon, which similarly leads to a clear reduction of the friction. It is likewise conceivable to produce the transmission element and/or the guide element of a material in which a solid lubricant such as for example MoS₂, Teflon or the like is embedded, so that because of the partial releasing of the solid lubricant during the movement of the transmission element in the guide element a lubrication and thus a reduce friction are achieved.

In addition to the reduction of the friction with respect to the guide element and/or of the transmission element, the friction in the region of the diaphragm or the diaphragm disc can also be reduced through a lubricating coating such as a Teflon layer. On the one hand, this reduces the actuator internal friction, can reduce the flexing work in the diaphragm and consequently increase the lifespan.

Such lubricating coating is to be also provided advantageously with respect to the spring element since the spring because of the larger spring travel likewise decisively contributes to the friction in the overall system of the actuator. Thus, a lubricating coating for example with Teflon can also be provided in the region of the spring.

More preferably when designing longitudinal grooves in the guide element, at least with respect to the longitudinal grooves, the housing interior is connected to the surroundings and thus dirt from the surroundings can enter the housing interior of the actuator through the longitudinal grooves. Thus it is not only advantageous in this case to equip the guide element on the outside with a dirt protection device in the form of sealing fins and/or in form of round brushes so that the dirt ingress in the housing interior can be at least reduced or completely prevented. For this purpose, sealing fins or round brushes can be attached to the outside of the guide element so that dirt particles at adhering to the transmission element are prevented from entering the housing interior through such a dirt protection device.

In addition, the guide bush for increasing the stiffness of the guide and reduction of the friction can be embodied as sinter bearing or slide bush.

Such an actuator can be employed in/on a charging device, more preferably in/on an exhaust gas turbocharger for the control for example of a variable turbine geometry or a wastegate valve.

Additional important features and advantages of the invention are obtained from the subclaims, from the drawings and from the corresponding figure description by means of the drawings.

It is to be understood that the features mentioned above and still to be explained below cannot only be used in the respective combination stated but also in other combinations or by themselves without leaving the scope of the present invention.

Preferred exemplary embodiments of the invention are showing in the drawings and are explained in more detail in the following description, while same reference characters refer to same or similar or functionally same components.

It shows, in each case schematically.

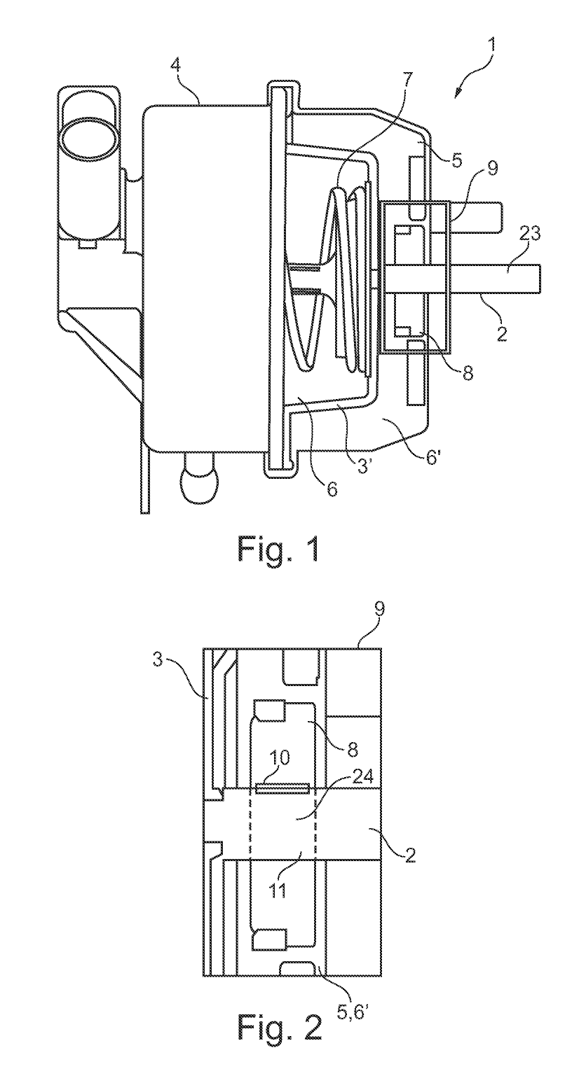

FIG. 1 a longitudinal section through a pneumatic actuator,

FIG. 2 an enlarged detail of FIG. 1,

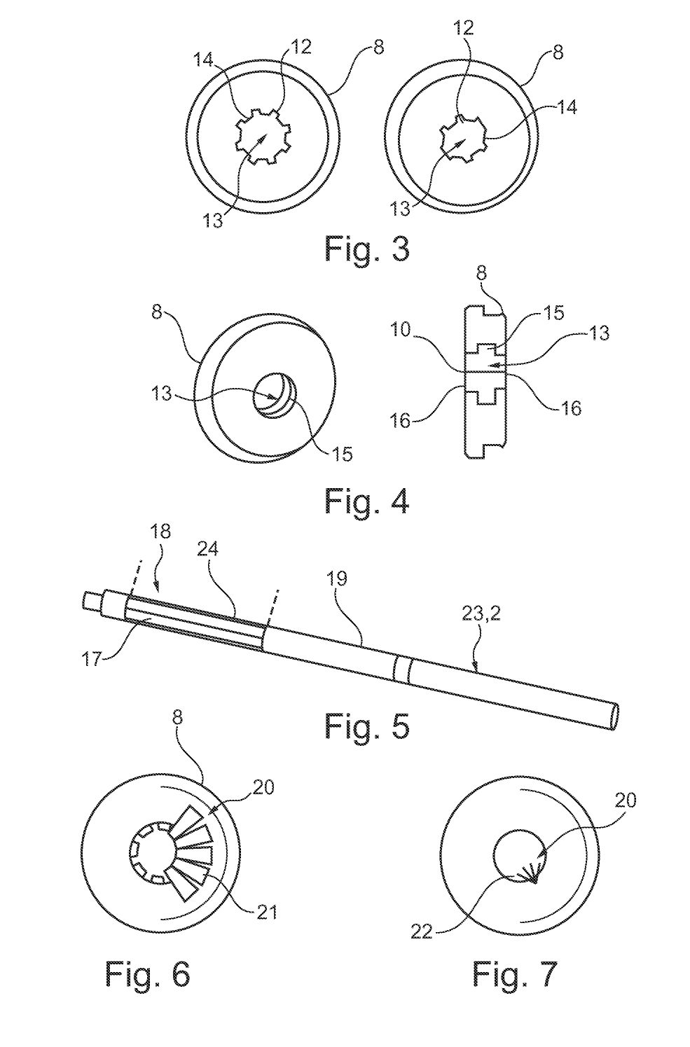

FIG. 3 a guide element with several longitudinal grooves,

FIG. 4 a guide element with a ring groove,

FIG. 5 a transmission element with several longitudinal grooves,

FIG. 6 a guide element with several sealing fins,

FIG. 7 a guide element with a brush insert.

FIG. 1 shows a pneumatic actuator 1 which is equipped with a transmission element 2 designed as steering or regulating rod. The transmission element 2 is connected to a diaphragm 3 which subdivides an interior 5 enclosed by a housing 4 in a pressure-type manner into two separate part spaces 6, 6′ separated from each other in a pressure-tight manner. Through a pressure differential between the part spaces 6, 6′ the diaphragm 3 is moved. The movement of the diaphragm 3 can occur at least in one direction against the spring force of a spring element 7. The spring element 7 contributes to the actuator 1 moving into an accurately defined starting position of the transmission element 2 at least at a predetermined pressure differential between the part spaces 6, 6′. In this embodiment of a pneumatic actuator 1 a translation movement along the longitudinal axis of the transmission element 2 is carried out by the transmission element 2.

The transmission element 2 is mounted in a guide element 8, wherein through the use of the guide element 8 a transmission of transverse forces acting on the transmission element 2 transversely to the longitudinal axis to the diaphragm 3 is reduced. In addition, the interior space 5 of the actuator 1 is sealed against environmental influences through the guide element 8 and because of the guidance of the transmission element 2 by the guide element 8 a position detection through a sensor which is not shown in the FIG. 1 can be carried out more accurately.

A detail 9 of the FIG. 1 is shown in the FIG. 2 for explaining a guide length 10. Here, the guide length 10 is that length of a region 11 of the transmission element 2 with which the transmission element 2 is arranged in the guide element 8. With an inner surface of the guide element 8 designed as annular surface the guide length 10 corresponds to the axial height of the annular surface.

In order to reduce a friction between the transmission element 2 and the guide element 8 an inner surface 13 of the guide element 8 facing the transmission element 2 and/or an outer surface 19 of the transmission element 2 facing the guide element 8 comprise/s at least one radial groove 12, 15, 17. The term radial groove 12, 15, 17 shall generally mean longitudinal grooves 12, ring grooves 15 and spiral grooves 17, whose groove depth extends in radial direction.

FIG. 3 shows a possible embodiment of a guide element 8 provided with several longitudinal grooves 12. Here, the longitudinal grooves 12 are regularly distributed in circumferential direction, wherein in the embodiment shown preferably eight longitudinal grooves 12 are arranged on an inner surface 13 of the guide element 8. Because of the formation of these longitudinal grooves 12, longitudinal webs running along the longitudinal axis of the guide element 8 are also formed as a matter of course.

The preferred embodiment of a guide element 8 shown in FIG. 4 comprises a ring groove 15 arranged in the middle of the interior surface 13. Because of the ring groove 15 a ring web 16, 16′ positioned at the end is consequently also formed in each case. Because of this the guide length 10 is formed of the same length with reduced friction surface, while the guide length 10 in each case is limited by a ring web 16, 16′ located opposite at the end. Advantageously, this results in that transverse forces acting on the transmission element 2 are less intensively transmitted to the diaphragm 3 compared with a round formation of the inner surface 13 of the guide element 8.

A possible embodiment of a transmission element 2 provided with several longitudinal grooves 17 is shown in FIG. 5. Here, a region 18 of the transmission element 2 arranged in the region 11 of the guide element 8 is provided on an outer surface 19 of the transmission element 2 with longitudinal grooves 17 arranged regularly in circumferential direction on the outer surface 19. In a preferred embodiment a total of eight longitudinal grooves 17 are regularly arranged in circumferential direction on the outer surface 19 of the transmission element 2. The region 18 of the transmission element 2 is not permanently arranged in the region 11 of the guide element 8 but characterizes that region of the transmission element 2 which because of its freedom of movement can be arranged within the region 11 of the guide element 8.

In other embodiments one or several ring grooves and/or one to several longitudinal grooves can be arranged on the transmission element 2 or on the guide element 8 each. In each case, these can be formed individually on the respective element 2, 8 or on both elements 2, 8 simultaneously. Likewise, a formation of spiral-shaped spiral grooves running in the manner of a thread on the transmission element 2 and/or on the guide element 8 is conceivable.

In addition, the guide element 8 can be equipped with a dirt protection device 20 in form of fins 21 as shown in FIG. 6 or in form of brush elements 22 as shown in FIG. 7. In the case of brush elements 22 it is also conceivable to equip the guide element 8 with a round brush. These dirt protection devices 20 are to be preferentially arranged on the side of the guide element 8 which in insulation position of the guide element 8 is orientated towards the surroundings of the actuator 1. If the transmission element 2 now moves in the guide element 8 dirt adhering to the transmission element 2 can now be wiped off or brushed off through the dirt protection device 20 and the ingress of dirt adhering to the transmission element 2 into the interior space 5 of the housing 4 is at least reduced if not even entirely suppressed.

The outward and return movement of the transmission element 2 can additionally be facilitated by a friction-reducing coating 24. Thus it is possible to provide a coating 24 of the transmission element 2 designed for example as regulating rod 23 with a Teflon layer, an MoS₂-layer, a chromium layer or the like. There, such lubricating coatings 24 can be applied to the entire transmission element 2 as well as merely partially in the region of the guide element 8 and in a lift region of the transmission element 2 during the operation. It is additionally conceivable, in contrast with a currently usual design of PPS, to produce the guide element 8 completely or at least in the guide region from Teflon, which likewise results in a clear reduction of the friction. Similarly, it is also conceivable to produce the transmission element 2 and/or the guide element 8 from a material in which a solid lubricant such as for example MoS₂, Teflon or the like is embedded, so that because of the partial releasing of the solid lubricant during the movement of the transmission element 2 in the guide element 8, a lubrication and thus a reduced friction are achieved.

In addition to the reduction of the friction with respect to the guide element 8 and/or of the transmission element 8, the friction in the region of the diaphragm 3 or the diaphragm disc can also be reduced through a lubricating coating 24, such as for example a Teflon layer. Such a lubricating coating 24 can also be advantageously provided with respect to the spring element 7, since the spring element 7 likewise decisively contributes to the friction in the overall system of the actuator 1.

1. An actuator comprising: a transmission element configured to transmit a mechanical regulating signal, a guide element and a transmission element mounted on the guide element, the guide element having an inner surface facing the transmission element, the transmission element having an outer surface facing the guide element and wherein the guide element includes at least one radial groove.

2. The actuator according to claim 1, wherein the at least one radial groove extends in a circumferential direction toward the transmission element.

3. The actuator according to claim 1, wherein the at least one radial groove includes at least one of a generally rectangular, triangular and trapezium-shaped cross section.

4. The actuator according to claim 1, wherein the at least one radial grove includes eight radial grooves extending in an axial direction of the guide element.

5. The actuator according to claim 1, wherein the at least one radial grove includes eight radial grooves extending in an axial direction of the transmission element.

6. The actuator according to claim 1, further comprising a plurality of webs configured to delimit the radial grooves, each having at least one of a generally rounded-off end region, a generally trapezium-shaped end region, a generally rectangular end region and a generally pointed end region.

7. A charging device, more preferably an exhaust gas turbocharger, with comprising: an actuator including a transmission element configured to transmit a mechanical regulating signal, a guide element and a transmission element mounted on the guide element, the guide element having an inner surface facing the transmission element, the transmission element having an outer surface facing the guide element, wherein the guide element includes at least one radial groove.

8. The charging device according to claim 7, wherein the at least one radial groove extends in a circumferential direction toward the transmission element.

9. The charging device according to claim 7, wherein the at least one radial groove includes at least one of a generally rectangular, triangular and trapezium-shaped cross section.

10. The charging device according to claim 7, wherein the at least one radial grove includes eight radial grooves extending in an axial direction of the guide element.

11. The charging device according to claim 7, wherein the at least one radial grove includes eight radial grooves extending in an axial direction of the transmission element.

12. The charging device according to claim 7, further comprising a plurality of webs configured to delimit the radial grooves, each having at least one of a generally rounded-off end region, a generally trapezium-shaped end region, a generally rectangular end region and a generally pointed end region.

13. The charging device according to claim 8, wherein the at least one radial groove includes at least one of a generally rectangular, triangular and trapezium-shaped cross section.

14. The charging device according to claim 13, wherein the at least one radial grove includes eight radial grooves extending in an axial direction of the guide element.

15. The charging device according to claim 13, wherein the at least one radial grove includes eight radial grooves extending in an axial direction of the transmission element.

16. The charging device according to claim 13, further comprising a plurality of webs configured to delimit the radial grooves, each having at least one of a generally rounded-off end region, a generally trapezium-shaped end region, a generally rectangular end region and a generally pointed end region.

17. The actuator according to claim 2, wherein the at least one radial groove includes at least one of a generally rectangular, triangular and trapezium-shaped cross section.

18. The actuator according to claim 17, wherein the at least one radial grove includes eight radial grooves extending in an axial direction of the guide element.

19. The actuator according to claim 17, wherein the at least one radial grove includes eight radial grooves extending in an axial direction of the transmission element.

20. The actuator according to claim 17, further comprising a plurality of webs configured to delimit the radial grooves, each having at least one of a generally rounded-off end region, a generally trapezium-shaped end region, a generally rectangular end region and a generally pointed end region.
